(19) United States
(12) Patent Application Publication
(10) Pub. No.: US 2008/0054757 A1
(43) Pub. Date: Mar. 6, 2008

(54) Tip-tilt actuator

(76) Inventors: Vladimir Anatolyevich Aksyuk, Westfield, NJ (US); Maria Elina Simon, New Providence, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/514,584

(22) Filed: Aug. 31, 2006

(51) Int. Cl. G02B 26/08; H02N 1/00

(52) U.S. Cl. 310/309; 359/225; 359/223

(57) ABSTRACT

A MEMS device that has desirable tip and tilt properties employs at least two electrostatic drives, each of which has its axis of rotation aligned with the center of a post attachment point, the post attachment point being coupled to a post that is further coupled to the plate that is to be tipped and tilted. Preferably, the electrostatic drives are comb drives arranged so that their axes of rotation are at right angles. Also preferably, in at least one direction, two comb drives are coupled to provide greater torque about a single axis.

### TECHNICAL FIELD

This invention relates to Micro-Electro-Mechanical-Systems (MEMS), and more particularly, to plates that can controllably tip and tilt but not piston.

### BACKGROUND OF THE INVENTION

Optical communication equipment often employs one or more micro-electromechanical systems (MEMS) devices. A typical MEMS device may be a structure that includes a plate that is movable, in response to one or more electrical control signals, so as to change its spatial orientation, e.g., its tip, tilt, and/or piston. Such a plate is often a mirror, in that it has at least one reflective surface. Several of such controllable mirrors may be grouped together into an array.

One application that uses an array of controllable mirrors is an optical cross-connect, in which each mirror in the array receives a different beam of light, where each beam may be supplied from a respective input optical fiber of an input optical fiber array. Each beam is reflected from the respective associated mirror to which it was directed and the resulting reflected beam can be directed to a different location, e.g., a location at which an appropriate output optical fiber is located, which may be part of an array of output optical fibers. The particular location, e.g., output optical fiber, to which the reflected beam is directed is a function of the orientation of the mirror.

Other optical applications for MEMS devices include wave selective switches, add-drop switches, wavelength attenuators, and wavelength blockers. Non-optical applications are also possible.

### SUMMARY OF THE INVENTION

We have recognized that for various MEMS applications it is often desirable that the tip and tilt functions of the plate being controlled be as independent as possible. The tip and tilt functions should also introduce as little piston motion as possible. Furthermore, in many applications, it is desirable that the point of rotation of the plate be as close as possible to its center of the plate. It is also desirable that when an array of such MEMS plates is formed that the plates of the array can be made with essentially no gaps between them.

A MEMS device that has good properties in these desirable areas is achieved, in accordance with the principles of the invention, by employing at least two electrostatic drives, each of which has its axis of rotation aligned with the center of a post attachment point, the post attachment point being coupled to a post that is further coupled to the plate that is to be tipped and tilted. Preferably, the electrostatic drives are comb drives. Also, preferably, the electrostatic drives are arranged so that their axes of rotation are at right angles. Also, preferably, in at least one direction, two comb drives are coupled to provide greater torque about a single axis.

In one embodiment of the invention, an electrostatic drive has a moveable plate and a fixed plate. The electrostatic drive is arranged so that a) its moveable plate is offset from a support by a moveable plate attachment spring, and b) the axis of rotation when the moveable plate moves in response to attraction to the fixed plate—upon application of a potential difference—is in the middle of the moveable plate attachment spring, i.e., half way between the moveable plate and the support. The moveable plate is coupled by a coupler and at least one coupling spring to at least one edge of a post attachment point. The at least one coupling spring provides the ability for motion in the orthogonal direction of the motion of the coupler to be substantially independent of the motion of the coupler. When the moveable plate of the electrostatic drive moves up, the coupler rotates in the same direction, causing the post attachment point to rotate about the rotation axis, which is through the middle of the moveable plate attachment spring. A similar arrangement in the orthogonal direction causes rotation about an orthogonal axis.

The post attachment point is coupled to a post, at the opposite end of which is the plate, which may be a mirror, the tipping and/or tilting is of which is ultimately being controlled. For each electrostatic drive, the coupler may be arranged such that its rotation causes the post attachment point to a) go up with respect to the substrate when the moveable plate goes up, or b) go down when the moveable plate goes up. The arrangement of the coupling of the comb drives to the post attachment point may be different for each axis about which rotation takes place

Advantageously, the tip and tilt functions of the plate are substantially independent while the tip and tilt functions introduce minimal piston motion. Further advantageously, the point of rotation may be located right beneath the center of the plate that is being controlled, being only separated therefrom by the preferably short length of the post. Additionally, the plate may be made large enough to entirely cover the driving mechanism, so when an array of such MEMS devices are formed the plates of the array can be formed with essentially no gaps between them.

In another embodiment of the invention, paired electrostatic drives may be arranged to also provide rotation in opposite directions about a rotation axis.

### BRIEF DESCRIPTION OF THE DRAWING

In the drawing:

FIG. 1 shows an exemplary MEMS device arranged in accordance with the principles of the invention;

FIG. 2 is a top view of the exemplary MEMS device shown in FIG. 1;

FIG. 3 shows another view of the exemplary MEMS device of FIG. 1 but in which each of at least two electrostatic drives have been energized; and

FIG. 4 shows another embodiment of the invention in which electrostatic drives are paired so as provide rotation in opposite directions about each rotation axis.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Unless otherwise explicitly specified herein, the drawings are not drawn to scale.

The term micro-electromechanical systems (MEMS) device as used herein is intended to mean an entire MEMS device or any portion thereof. Thus, if a portion of a MEMS device is inoperative, or if a portion of a MEMS device is occluded, such a MEMS device is nonetheless considered to be a MEMS device for purposes of the present disclosure.

In the description, identically numbered components within different ones of the FIGS. refer to the same components.

FIG. 1 shows an exemplary MEMS device arranged in accordance with the principles of the invention. Shown in FIG. 1 are a) electrostatic drives 101, including electrostatic drive 101-1 and optional electrostatic drive 101-2; b) electrostatic drive 103; c)post attachment point 105; d) coupler 107, e) coupler 109; f) post 111; and g) plate 113.

Electrostatic drive 101-1 includes 1) moveable plate support 131, 2) moveable plate support spring 133, 3) moveable plate 135, and 4) fixed plate 137. Moveable plate support 131 is used to anchor and hold offset from substrate 115 moveable plate support spring 133. In turn, moveable plate support spring 133 holds moveable plate 135 offset from substrate 115. In its rest position, moveable plate 135 is displaced from, and preferably parallel to, fixed plate 137. Electrostatic drive 101-1 may be a flat plate drive or a comb drive, in which case comb projections 139 are formed on each of moveable plate 135 and fixed plate 137.

Moveable plate support spring 133 may be a so-called serpentine spring, which is a long spring having multiple turns. When a potential difference is applied between movable plate 135 and fixed plate 137, moveable plate 135 moves somewhat upwards and toward fixed plate 137, essentially rotating about an axis of rotation that is parallel to moveable plate support 131 and which is located at the midway portion of moveable plate support spring 133. By the midway portion of moveable plate support spring 133 it is meant the line of moveable plate support spring 133 that is equidistant from moveable plate support 131 and moveable plate 135 when moveable plate support spring 133 is in its rest position. Generally, this point may be identified based on the number of turns in support spring 133.

Better results are likely to be obtained when moveable plate support spring 133 is engineered to be more likely to provide torsional motion as opposed to linear extension when pulled by moveable plate 135. Those of ordinary skill in the art will readily be able to engineer moveable plate support spring 133 to be more likely to provide torsional motion as opposed to stretching and bending. Preferably, essentially only torsion is provided.

Coupler 107 is coupled to moveable plate 135, e.g., near one end thereof. At another location along coupler 107 coupling spring 171 couples coupler 107 to post attachment point 105. Preferably, coupler 107 and coupling spring 171 are formed so that they hold post attachment point 105 aligned with the axis of rotation about which moveable plate 135 is essentially rotating, e.g., an axis of rotation that is parallel to moveable plate support 131 and located at the midway portion of moveable plate support spring 133. When optional electrostatic drive 101-2 is not included, coupler 107 may extend essentially only as far as the location at which it is coupled to coupling spring 171.

Coupling spring 171 is preferably arranged to be more likely to provide torsional motion as opposed to stretching and bending. Preferably, coupling spring 171 essentially provides essentially only torsional movement. When moveable plate 135 moves somewhat upwards and toward fixed plate 137, essentially rotating about an axis of rotation that is parallel to moveable plate support 131 and which is located at the midway portion of moveable plate support spring 133, it causes corresponding rotation in coupler 107. Indeed, as moveable plate 135 rotates, coupler 107 likewise rotates, thereby causing the point at which coupler 107 is attached to coupling spring 171 to also rotate, e.g., to move downward, i.e., toward substrate 115. Correspondingly, the opposite point of coupling spring 171, i.e., the point at which it is attached to post attachment point 105, rotates about the same axis of rotation as for the rotation moveable plate 135.

Post attachment point 105 is also coupled to one end of post 111, which in turn is coupled at its opposite end to plate 113. Movement of post attachment point 105 is transmitted via post 111 to plate 113. Thus, plate 113 essentially reproduces the movement of post attachment point 105. Plate 113 may have at least one of its faces, e.g., the one facing away from substrate 115, processed to improve its reflectivity, e.g., the surface may be polished and/or coated with a reflection enhancing coating, such as metal.

Similar to electrostatic drive 101-1, electrostatic drive 103 includes 1) moveable plate support 151, 2) moveable plate support spring 153, 3) moveable plate 155, and 4) fixed plate 157. Moveable plate support 151 is used to anchor and hold offset from substrate 115 moveable plate support spring 153. In turn, moveable plate support spring 153 holds moveable plate 155 offset from substrate 115. In its rest position, moveable plate 155 is displaced from, and parallel to, fixed plate 157. Electrostatic drive 103 may be a flat plate drive or a comb drive, in which case comb projections 159 are formed on each of moveable plate 155 and fixed plate 157.

Moveable plate support spring 153 may be a so-called serpentine spring, which is a long spring having multiple turns. When a potential difference is applied between movable plate 155 and fixed plate 157, moveable plate moves somewhat upwards and toward fixed plate 157, essential rotating about an axis of rotation that is parallel to moveable plate support 151 and which is located at the midway portion of moveable plate support spring 153. By midway portion of the spring it is meant the line of the spring that is equidistant from moveable plate support 151 and moveable plate 155 when moveable plate support spring 153 is in its rest position. Generally, this point may be identified based on the number of turns in support spring 153.

Better results are likely to be obtained when moveable plate support spring 153 is engineered to be more likely to provide torsional motion as opposed to linear extension when pulled by moveable plate 155. Those of ordinary skill in the art will readily be able to engineer moveable plate support spring 153 to be more likely to provide torsional motion as opposed to stretching and bending. Preferably, essentially only torsion is provided.

Coupler 109 is coupled to moveable plate 155. Coupler 109 is also coupled post attachment point 105, e.g., at two points via coupling springs 191 and 193 in the manner shown in FIG. 1. Coupling springs 191 and 193 are preferably arranged to be more likely to provide torsional motion as opposed to stretching and bending. Further preferably, coupling springs 191 and 193 essentially only provide for torsional movement. Coupler 109 and coupling springs 191 and 193 preferably are arranged so that they hold post attachment point 105 aligned with the axis of rotation about which moveable plate 155 is essentially rotating, e.g., an axis of rotation that is parallel to moveable plate support 151 and located at the midway portion of moveable plate support spring 153.

When moveable plate 155 moves somewhat upwards and toward fixed plate 157, essentially rotating about an axis of rotation that is parallel to moveable plate support 151 and which is located at the midway portion of moveable plate support spring 153, it causes corresponding rotation in coupler 109. Indeed, as moveable plate 155 rotates, that part of coupler 109 at which coupling spring 191 likewise rotates, thereby causing the point of post attachment point 105 to which coupling spring 191 is attached to also rotate, e.g., to move downward, i.e., toward substrate 115. Correspondingly, that part of coupler 109 at which coupling spring 193 is located rotates upward. The rotating movement of springs 191 and 193 causes the point of post attachment point 105 to which coupling spring 193 is attached to correspondingly rotate. Thus, post attachment point 105 rotates about the axis of rotation through it.

Preferably, electrostatic drives 101 and 103 are arranged so that their axes of rotation are at right angles. Although doing so is not necessary, it simplifies controlling the rotation of plate 113.

Optional electrostatic drive 101-2 is arranged to rotate about the same axis as electrostatic drive 101-1 in a manner whereby the torque provided by each of electrostatic drives 101 is combined so as to provide greater torque about that axis. Although electrostatic drive 101-2 is shown in FIG. 1 to be essentially identical to electrostatic drive 101-1, it need not be. As shown in FIG. 1, electrostatic drive 101-2 includes 1) moveable plate support 141, 2) moveable plate support spring 143, 3) moveable plate 145, and 4) fixed plate 147. Moveable plate support 141 is used to anchor and hold offset from substrate 115 moveable plate support spring 143. In turn, moveable plate support spring 143 holds moveable plate 145 offset from substrate 115. In its rest position, moveable plate 145 is displaced from, and parallel to, fixed plate 147. Electrostatic drive 101-2 may be a flat plate drive or a comb drive, in which case comb projections 149 are formed on each of moveable plate 145 and fixed plate 147.

Moveable plate support spring 143 may be a so-called serpentine spring, which is a long spring having multiple turns. When a potential difference is applied between movable plate 145 and fixed plate 147, moveable plate 145 moves somewhat upwards and toward fixed plate 147, essentially rotating about an axis of rotation that is parallel to moveable plate support 141 and which is located at the midway portion of moveable plate support spring 143. By midway portion of the spring it is meant the point of the spring that is equidistant from moveable plate support 141 and moveable plate 145 when moveable plate support spring 143 is in its rest position. Generally, this point may be identified based on the number of turns in support spring 143.

Better results are likely to be obtained when moveable plate support spring 143 is engineered to be more likely to provide torsional motion as opposed to linear extension when pulled by moveable plate 145. Those of ordinary skill in the art will readily be able to engineer moveable plate support spring 143 to be more likely to provide torsional motion as opposed to stretching and bending. Preferably, essentially only torsion is provided.

In the embodiment of the invention shown in FIG. 1, when optional electrostatic drive 101-2 is included, coupler 107 is used to couple both electrostatic drives 101 together and to transfer the torque generated thereby to spring 171, and ultimately, as described hereinabove, to moveable plate 113.

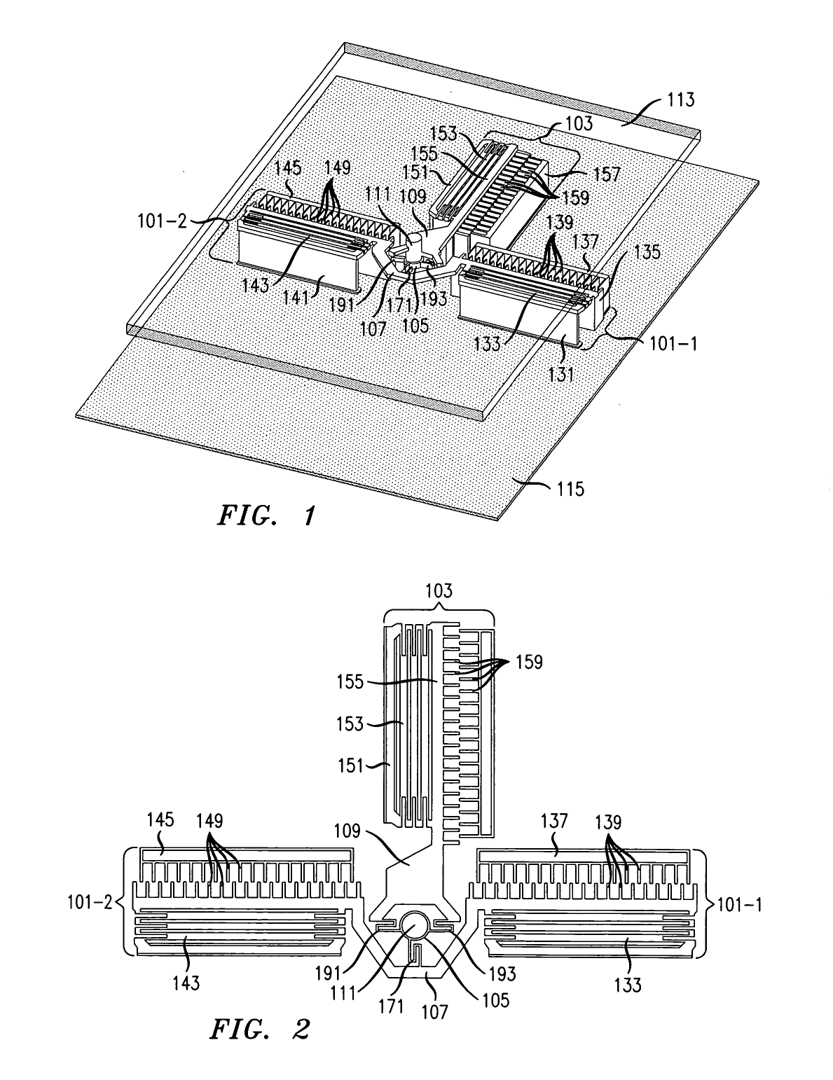

FIG. 2 is a top view of the embodiment of the invention shown in FIG. 1.

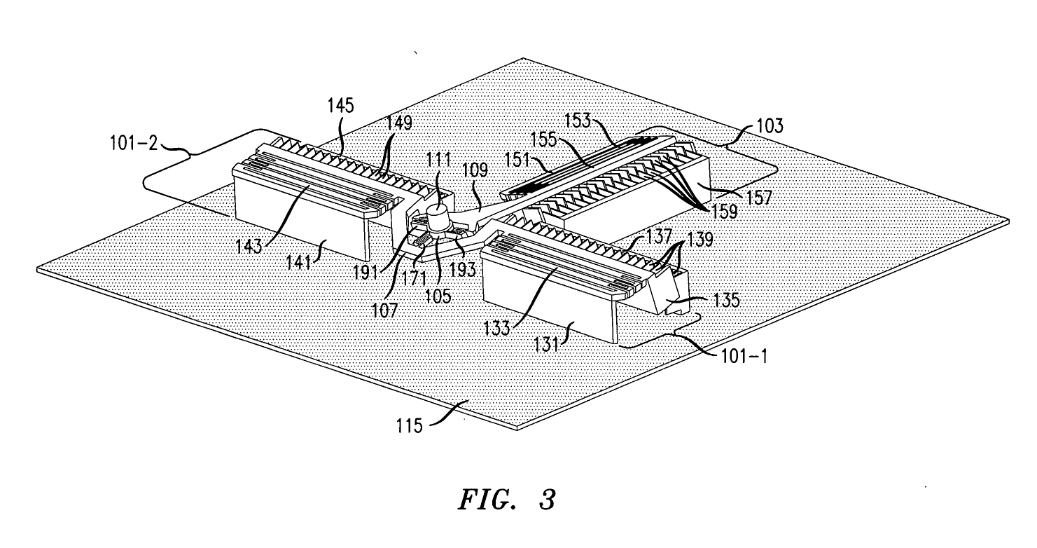

FIG. 3 shows another view of the embodiment of the invention shown in FIG. 1 but in which each of at least electrostatic drives 101-1 and electrostatic drive 103 have been energized.

By inverting the location of coupler 107 and electrostatic drive 103, the rotation effect caused by moveable plate 135 is reversed, in that the movement of moveable plate 135 toward fixed plate 137 causes the point at which coupler 107 is coupled to spring 171 to move upward, although the tilting of the plate remains the same.

Note that if electrostatic drive 101-2 would be inverted, so that the location of support 141 and fixed plate 145 were reversed, it is possible to extend the range of the rotation about the axis of rotation.

One or more of moveable plate support springs 133, 143, and 153 may be replaced with other spring structures, e.g., one or more flexible bars or a pair of springs near the ends of the plates being coupled. Also, one or more of moveable plate supports 131, 141, and 151 may be replaced with a different support structure, e.g., one or more support posts and/or wall sections from which the appropriate one of moveable plate support springs 133, 143, and 153 would be suspended.

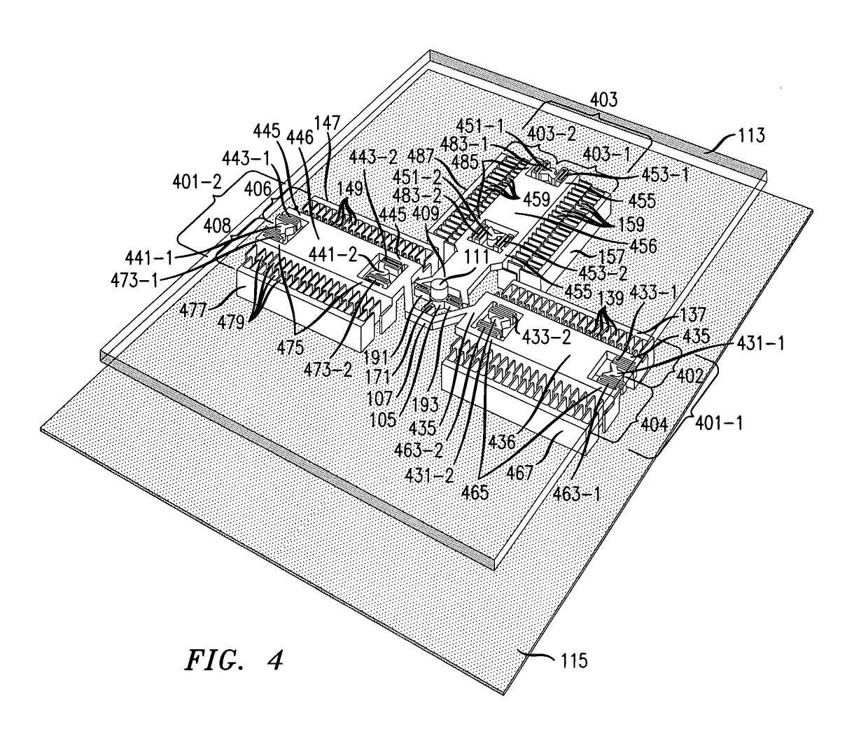

Shown in FIG. 4 is another embodiment of the invention in which electrostatic drives are paired so as provide rotation in opposite directions about each rotation axis. Such an arrangement may provide a greater degree of tip or tilt. Shown in FIG. 4 are a) electrostatic drives 401, including electrostatic drive 401-1 and optional electrostatic drive 401-2; b) electrostatic drive 403; c) post attachment point 105; d) coupler 107, e) coupler 409; f) post 111; and g) plate 113.

Electrostatic drive 401-1 has two portions, 402 and 404, which are, optionally, mirror images of each other.

Electrostatic drive portion 402 includes 1) moveable plate support posts 431-1 and 431-2, 2) moveable plate support springs 433-1 and 433-2, 3) moveable plate 435, and 4) fixed plate 137. Moveable plate support posts 431-1 and 431-2 are used to anchor and hold offset from substrate 115 moveable plate support springs 433-1 and 433-2. In turn, moveable plate support springs 433-1 and 433-2 hold moveable plate 435 offset from substrate 115. In its rest position, moveable plate 435 is displaced from, and parallel to, fixed plate 137. Electrostatic drive portion 402 may be a flat plate drive or a comb drive, in which case comb projections 139 are formed on each of moveable plate 435 and fixed plate 137.

Electrostatic drive portion 404 includes 1) moveable plate support posts 431-1 and 431-2, 2) moveable plate support springs 463-1 and 463-2, 3) moveable plate 465, and 4) fixed plate 467. Moveable plate support posts 431-1 and 431-2 are used to anchor and hold offset from substrate 115 moveable plate support springs 463-1 and 463-2. In turn, moveable plate support springs 463-1 and 463-2 hold moveable plate 465 offset from substrate 115. In its rest position, moveable plate 465 is displaced from, and parallel to, fixed plate 467. Electrostatic drive portion 404 may be a flat plate drive or a comb drive, in which case comb projections 139 are formed on each of moveable plate 465 and fixed plate 467.

Coupling plate 436 couples moveable plates 435 and 465 so as to couple the motion of one to the other.

When a potential difference is applied between movable plate 435 and fixed plate 137, moveable plate 435 moves somewhat upwards and toward fixed plate 137, essentially rotating about an axis of rotation that is located along the line between moveable plate support posts 431-1 and 431-2, assuming moveable plate support springs 433-1 and 433-2 each have the same length in their respective rest positions. Note that this somewhat different than the corresponding situation for the embodiment of the invention shown in FIG. 1, which is due to the counterbalancing force of springs 463-1 and 463-2 which is transmitted via plate 436. Similarly, when a potential difference is applied between movable plate 465 and fixed plate 467, moveable plate 465 moves somewhat upwards and toward fixed plate 467, essentially rotating about an axis of rotation that is located along the line between moveable plate support posts 431-1 and 431-2, assuming moveable plate support springs 463-1 and 463-2 each have the same length in their respective rest positions. Preferably a potential difference is only applied between plates 435 and 137 or 465 and 467 at any one time, as the rotations such applied potentials cause are in opposite directions, and hence would tend to cancel each other.

Coupler 107 is coupled to coupling plate 436, preferably at least at a point along its axis of rotation, which is also, preferably, along the axis between moveable plate support posts 431-1 and 431-2. At a second point coupling spring 171 of coupler 107 couples coupler 107 to post attachment point 105. Preferably, coupler 107 and coupling spring 171 are formed so that they hold post attachment point 105 aligned with the axis of rotation of coupling plate 436. When optional electrostatic drive 401-2 is not included, coupler 107 need not extend beyond the point of coupling spring 171.

As in the embodiment of the invention in FIG. 1, coupling spring 171 is preferably arranged to be more likely to provide torsional motion as opposed to stretching and bending. Preferably, essentially only torsion is provided. When moveable plate 435 moves somewhat upwards and toward fixed plate 437, essentially rotating about an axis of rotation that is along the axis between moveable plate support posts 431-1 and 431-2, as noted, it causes corresponding rotation in coupler 107. Indeed, as moveable plate 435 rises, coupler 107 likewise rotates about the same axis, thereby causing the point at which coupling spring 171 is attached to coupler 107 to rotate downward, i.e., toward substrate 115. Correspondingly, the opposite point of coupling spring 171 at which it is attached to post attachment point 105 rotates about the axis of rotation.

Likewise, when moveable plate 465 moves somewhat upwards and toward fixed plate 467, essentially rotating about an axis of rotation that is along the axis between moveable plate support posts 431-1 and 431-2, it causes corresponding rotation in coupler 107. This rotation is in the opposite direction from that produced by movement of plate 435. As moveable plate 465 rises, coupler 107 likewise rotates about the same axis, thereby causing the point at which coupling spring 171 is attached to coupler 107 to rotate upward, i.e., away from substrate 115. Correspondingly, the opposite point of coupling spring 171 at which it is attached to post attachment point 105 rotates about the axis of rotation.

As in FIG. 1, post attachment point 105 is also coupled to one end of post 111, which in turn is coupled at its opposite end to plate 113. Movement of post attachment point 105 is transmitted via post 111 to plate 113. Thus, plate 13 essentially reproduces the movement of post attachment point 105.

Electrostatic drive 403 has two portions, 403-1 and 403-2, which are, optionally, mirror images of each other.

Electrostatic drive portion 403-1 includes 1) moveable plate support posts 451-1 and 451-2, 2) moveable plate support springs 453-1 and 453-2, 3) moveable plate 455, and 4) fixed plate 157. Moveable plate support posts 451-1 and 451-2 are used to anchor and hold offset from substrate 115 moveable plate support spring 453. In turn, moveable plate support springs 453-1 and 453-2 hold moveable plate 455 offset from substrate 115. In its rest position, moveable plate 455 is displaced from, and parallel to, fixed plate 157. Electrostatic drive portion 403-1 may be a flat plate drive or a comb drive, in which case comb projections 159 are formed on each of moveable plate 455 and fixed plate 157.

Electrostatic drive portion 403-2 includes 1) moveable plate support posts 451-1 and 451-2, 2) moveable plate support springs 483-1 and 483-2, 3) moveable plate 485, and 4) fixed plate 487. Moveable plate support posts 481-1 and 481-2 are used to anchor and hold offset from substrate 115 moveable plate support springs 483-1 and 483-2. In turn, moveable plate support springs 483-1 and 483-2 hold moveable plate 485 offset from substrate 115. In its rest position, moveable plate 485 is displaced from, and parallel to, fixed plate 487. Electrostatic drive portion 404 may be a flat plate drive or a comb drive, in which case comb projections 459 are formed on each of moveable plate 485 and fixed plate 487.

Coupling plate 456 couples moveable plates 455 and 485 so as to couple the motion of one to the other.

When a potential difference is applied between movable plate 455 and fixed plate 157, moveable plate 455 moves somewhat upwards and toward fixed plate 157, essentially rotating about an axis of rotation that is located along the line between moveable plate support posts 451-1 and 451-2, assuming moveable plate support springs 453-1 and 453-2 each have the same length in their respective rest positions. Note that this somewhat different than the corresponding situation for the embodiment of the invention shown in FIG. 1, which is due to the counterbalancing force of springs 483-1 and 483-2 which is transmitted via plate 456. Similarly, when a potential difference is applied between movable plate 485 and fixed plate 487, moveable plate 485 moves somewhat upwards and toward fixed plate 487, essentially rotating about an axis of rotation that is located along the line between moveable plate support posts 451-1 and 451-2, assuming moveable plate support springs 483-1, and 483-2 each have the same length in their respective rest positions. Preferably a potential difference is only applied between plates 455 and 137 or 485 and 487 at any one time, as the rotations such applied potentials cause are in opposite directions, and hence would tend to cancel each other.

Coupler 409 is coupled to coupling plate 456, preferably at least at a point along its axis of rotation, which is also, preferably, along the axis between moveable plate support posts 451-1 and 451-2. Coupler 409 is coupled at two points to post attachment point 105, via coupling springs 191 and 193. Coupling springs 191 and 193 are preferably arranged to be more likely to provide torsional motion as opposed to stretching and bending. Preferably, essentially only torsion is provided. Coupler 409 and coupling springs 191 and 193 are arranged so that they hold post attachment point 105 aligned with the axis of rotation about which moveable plate 455 is essentially rotating.

When moveable plate 455 moves somewhat upwards and toward fixed plate 157, essentially rotating about an axis of rotation that is along the axis between moveable plate support posts 451-1 and 451-2, it causes corresponding rotation in coupler 109. Indeed, as moveable plate 455 rises, that part of coupler 409 at which coupling spring 193 is attached rises, as does the point of post attachment point 105 to which coupling spring 193 is attached. Correspondingly, that part of coupler 409 at which coupling spring 191 is attached moves downward, as does the point of post attachment point 105 to which coupling spring 191 is attached. Thus, post attachment point 105 rotates about the axis of rotation.

Likewise, when moveable plate 485 moves somewhat upwards and toward fixed plate 487, essentially rotating about an axis of rotation that is along the axis between moveable plate support posts 451-1 and 451-2, it causes motion in coupler 409. Indeed, as moveable plate 485 rises, that part of coupler 409 at which coupling spring 193 is attached rises, as does the point of post attachment point 105 to which coupling spring 193 is attached. Correspondingly, that part of coupler 409 at which coupling spring 191 is attached moves downward, as does the point of post attachment point 105 to which coupling spring 191 is attached. Thus, post attachment point 105 rotates about the axis of rotation through it.

Again, as in FIG. 1, movement of post attachment point 105 is transmitted via post 111 to plate 113 so that plate 113 essentially reproduces the movement of post attachment point 105.

Preferably, electrostatic drives 401-1 and 403 are arranged so that their axes of rotation are at right angles. Although doing so is not necessary, it simplifies controlling the rotation of plate 113.

Optional electrostatic drive 401-2 is arranged to rotate about the same axis as electrostatic drive 401-1 in a manner whereby the torque provided by each of electrostatic drives 401 is combined so as to provide greater torque about a single axis. Electrostatic drive 401-1 has two portions, 406 and 408, which are, optionally, mirror images of each other.

Electrostatic drive portion 406 includes 1) moveable plate support posts 441-1 and 441-2, 2) moveable plate support springs 443-1 and 443-2, 3) moveable plate 445, and 4) fixed plate 147. Moveable plate support posts 441-1 and 441-2 are used to anchor and hold offset from substrate 115 moveable plate support springs 443-1 and 443-2. In turn, moveable plate support springs 443-1 and 443-2 hold moveable plate 445 offset from substrate 115. In its rest position, moveable plate 445 is displaced from, and parallel to, fixed plate 147. Electrostatic drive portion 406 may be a flat plate drive or a comb drive, in which case comb projections 149 are formed on each of moveable plate 445 and fixed plate 147.

Electrostatic drive portion 408 includes 1) moveable plate support posts 441-1 and 441-2, 2) moveable plate support springs 473-1 and 473-2, 3) moveable plate 475, and 4) fixed plate 477. Moveable plate support posts 471-1 and 471-2 are used to anchor and hold offset from substrate 115 moveable plate support springs 473-1 and 473-2. In turn, moveable plate support springs 473-1 and 473-2 hold moveable plate 475 offset from substrate 115. In its rest position, moveable plate 475 is displaced from, and parallel to, fixed plate 477. Electrostatic drive portion 404 may be a flat plate drive or a comb drive, in which case comb projections 479 are formed on each of moveable plate 475 and fixed plate 477.

Coupling plate 446 couples moveable plates 445 and 475 so as to couple the motion of one to the other.

When a potential difference is applied between movable plate 445 and fixed plate 147, moveable plate 445 moves somewhat upwards and toward fixed plate 147, essentially rotating about an axis of rotation that is located along the line between moveable plate support posts 441-1 and 441-2, assuming moveable plate support springs 443-1 and 443-2 each have the same length in their respective rest positions. Note that this somewhat different than the corresponding situation for the embodiment of the invention shown in FIG. 1, which is due to the counterbalancing force of springs 473-1 and 473-2 which is transmitted via plate 446. Similarly, when a potential difference is applied between movable plate 475 and fixed plate 477, moveable plate 475 moves somewhat upwards and toward fixed plate 477, essentially rotating about an axis of rotation that is located along the line between moveable plate support posts 441-1 and 441-2, assuming moveable plate support springs 473-1 and 473-2 each have the same length in their respective rest positions. Preferably a potential difference is only applied between plates 445 and 147 or 475 and 477 at any one time, as the rotations such applied potentials cause are in opposite directions, and hence would tend to cancel each other.

Coupler 107 is also coupled to coupling plate 446, preferably at its axis of rotation, which is also, preferably, along the axis between moveable plate support posts 441-1 and 441-2. When moveable plate 445 moves somewhat upwards and toward fixed plate 447, essentially rotating about an axis of rotation that is along the axis between moveable plate support posts 441-1 and 441-2, it causes corresponding rotation in coupler 107. Indeed, as moveable plate 445 rises, coupler 107 likewise rotates about the same axis, thereby causing the point at which coupling spring 171 is attached to coupler 107 to rotate downward, i.e., toward substrate 115. Correspondingly, the opposite point of coupling spring 171, at which it is attached to post attachment point 105, rotates about the axis of rotation.

Likewise, when moveable plate 475 moves somewhat upwards and toward fixed plate 477, essentially rotating about an axis of rotation that is along the axis between moveable plate support posts 441-1 and 441-2, it causes corresponding rotation in coupler 107. This rotation is in the opposite direction from that produced by movement of plate 445. As moveable plate 475 rises, coupler 107 likewise rotates about the same axis, thereby causing the point at which coupling spring 171 is attached to coupler 107 to rotate upward, i.e., away from substrate 115. Note that the torque produced by the motion of moveable plates 435 and 445 additively combines, as does the torque produced by the motion of moveable plates 465 and 475.

What is claimed is:

1. Apparatus, comprising
a post attachment point;
at least two electrostatic drives, each of which has its axis of rotation aligned with the center of said post attachment point; and
at least two couplers, each of said couplers being coupled to at least one respective coupling spring, each of said couplers coupling an axis of rotation of at least one of said electrostatic drives to said post attachment point.

2. The invention as defined in claim 1 further comprising a post coupled at a first end thereof to said post attachment point.

3. The invention as defined in claim 2 further comprising a plate coupled to a second end of said post that is opposite to said first end.

4. The invention as defined in claim 1 wherein at least one of said electrostatic drives is a comb drive.

5. The invention as defined in claim 1 wherein at least one of said electrostatic drives is a plate drive.

6. The invention as defined in claim 1 wherein, in at least one of said electrostatic drives, a moveable plate is held offset from a fixed support by at least one moveable plate spring.

7. The invention as defined in claim 6 wherein said at least one moveable plate spring is a serpentine spring.

8. The invention as defined in claim 6 wherein said axis of rotation of said at least one of said electrostatic drives is located perpendicular to the turns of said spring at the midpoint of the turns based on the number of turns.

9. The invention as defined in claim 6 wherein said axis of rotation of said at least one of said electrostatic drive is parallel to said moveable plate of said electrostatic drive and located at a midway portion of said moveable plate spring.

10. The invention as defined in claim 6 wherein said fixed support comprises a wall.

11. The invention as defined in claim 6 wherein said fixed support comprises at least one post.

12. The invention as defined in claim 6 wherein said at least one moveable plate spring is adapted to primarily restrict said moveable plate to torsional motion.

13. The invention as defined in claim 1 wherein said electrostatic drives are arranged so that their respective axes of rotation are at right angles to each other.

14. The invention as defined in claim 1 further comprising a third electrostatic drive having an axis of rotation that has a common axis of rotation with at least one of said at least two electrostatic drives and being coupled to said one of said at least two electrostatic drives along said common axis of rotation.

15. The invention as defined in claim 14 wherein at least two of said electrostatic drives that have said common axis of rotation are coupled so as to combine the torque each respectively provides about said common axis of rotation.

16. The invention as defined in claim 14 wherein at least two of said electrostatic drives that have said common axis of rotation are coupled so as to provide rotation in each direction about said common axis.

17. The invention as defined in claim 1 wherein at least one of said coupling springs is arranged to allow independent rotation of said post attachment point about a different axis than the axis about which said coupler, which is coupled to said at least one of said coupling springs, rotates said post attachment point.

18. The invention as defined in claim 1 wherein at least one of said couplers moves the point at which it is coupled to said post attachment point in the same direction as said coupler moves.

19. The invention as defined in claim 1 wherein at least one of said couplers is attached to said post attachment point at a plurality of locations and said at least one coupler moves a first point at which it is coupled to said post attachment point in one direction and moves a second point at which it is coupled to said post attachment point in the opposite direction.

20. The invention as defined in claim 1 wherein at least one of said electrostatic drives is adapted to rotate both positively and negatively about its axis of rotation.

21. The invention as defined in claim 20 wherein said at least one of said electrostatic drives comprises two electrostatic drive portions coupled by a common plate to which is coupled a respective moveable plate for each of said electrostatic drive portion.

22. The invention as defined in claim 21 wherein said common plate is suspended from a support structure.

23. The invention as defined in claim 22 wherein said support structure is at least two posts aligned defining an axis between them which is said axis of rotation of said electrostatic drive.

24. At least two electrostatic drives, each of said electrostatic drives being coupled to a post attachment point such that said post attachment point is adapted to move in tip or tilt in response to rotation of at least one of said electrostatic drives, wherein the motion of said post attachment point induced by any one of said electrostatic drives is substantially independent of the motion induced by any other one of said electrostatic drives.

25. The invention as defined in claim 24 wherein each of said electrostatic drives is coupled to said post attachment point via at least one spring.

26. The invention as defined in claim 24 further comprising respective coupling means for each of said electrostatic drives, each of said means for coupling coupling its associated one of said electrostatic drives to said post attachment point.

27. The invention as defined in claim 26 further wherein each of said coupling means includes at least one spring.

28. A method for use in a operating a MEMS device, comprising the steps of:
rotating a first electrostatic drive around a first axis of rotation so as to induce a first motion in post connection point;
rotating a second electrostatic drive around a second axis of rotation so as to induce a second motion in post connection point;
wherein said post connection point moves said first motion and said second motion substantially independently whereby the motion of said post connection point is essentially a superposition of said first motion and said second motion.

29. The invention as defined in claim 28 wherein said first and second axis of rotation are orthogonal.

30. The invention as defined in claim 28 wherein at least one of said first motion and said second motion is one of positive and negative with respect to a rest position of said electrostatic drive.

31. Apparatus, comprising:
at least two electrostatic drive means, each of which has its axis of rotation aligned with the center;
means for attaching a post to each of said electrostatic drive means that produces a torque about an axis of rotation, of said post attachment point; and
at least two couplers, each of said couplers including at least one coupling spring, each of said couplers coupling an axis of rotation of at least one of said electrostatic drives to said post attachment point.
